(19) United States
(12) Patent Application Publication
(10) Pub. No.: US 2026/0360979 A1
(43) Pub. Date: Nov. 12, 2026

(54) WIDEBAND OMNIDIRECTIONAL ANTENNA

(71) Applicant: SIRIO ANTENNE S.R.L., Volta Mantovana (MN) (IT)

(72) Inventor: Lorenzo MEZZADRELLI, Marmirolo (MN) (IT)

(21) Appl. No.: 19/666,938

(22) Filed: May 4, 2026

(30) Foreign Application Priority Data
May 6, 2025 (IT) 102025000010017

(51) Int. Cl. H01Q 5/385; H01Q 5/25

(52) U.S. Cl. CPC H01Q 5/385; H01Q 5/25

(57) ABSTRACT

A wideband omnidirectional antenna includes at least one radiating body provided with at least an active element, made of electrically conductive material and configured to be connected to at least a feed line, with at least a central parasitic element positioned centrally relative to the radiating body and provided with at least one pair of separate conductive components spaced apart from each other, and with at least a pair of lateral parasitic elements, positioned on the opposite sides of the central parasitic element, wherein the active element is at least partly superposed both on the central parasitic element, and on the pair of lateral parasitic elements, the parasitic elements being made of electrically conductive material and being electrically isolated from each other.

This application claims priority to Italian Patent Application 102025000010017 filed May 6, 2025, the entirety of which is incorporated by reference herein.

### BACKGROUND OF THE INVENTION

This invention relates to a wideband omnidirectional antenna.

In recent years, the wireless communications sector has seen considerable technological evolution. In particular, with the gradual development of mobile communication standards (from 2G to the current 5G and beyond), there has been a significant increase in the bandwidth required of the hardware involved, such as antennas.

In general, antennas may be classed in two main categories: directional antennas, which focus the signal mainly in a preferred direction, and omnidirectional antennas, which radiate and receive signals practically evenly in all directions in a plane.

Omnidirectional antennas are used in many services, such as cellular networks, Wi-Fi, IoT, home automation, drones and smart vehicles, to name just a few.

Moreover, a need increasingly felt in the sector is that of using a single antenna to operate on multiple separate frequency bands. Therefore, so-called wideband, dual band or multi-band antennas were developed, capable of effectively operating on multiple frequency ranges, simultaneously supporting different communication standards (for example Wi-Fi, LTE, 5G) without the need to duplicate the hardware.

Some prior art omnidirectional antennas need the presence of a ground plane, that is to say, conductive metal surfaces placed at the base or near the antenna, whose function is electromagnetic reflection. Generally, the ground plane is not supplied with the antenna itself but is part of the equipment on which the antenna is installed. With respect to an improvement in performance, those elements, however, increase antenna dimensions, costs and construction and installation complexity.

Prior art omnidirectional antennas have several problems.

Firstly, they have limited bandwidth, that is to say, a relatively narrow frequency range within which the antenna is capable of operating efficiently. In other words, they can transmit and/or receive signals only within a specific frequency band, with performance greatly deteriorated outside it. Even in the case of dual band or multi-band antennas, the bands involved are limited.

Secondly, conventional omnidirectional antennas are subject to compromises between dimensions and radiative performance: small antennas often do not guarantee an adequate and constant gain across the entire operating band. Moreover, the bandwidth of that type of antennas is limited.

Thirdly, impedance matching, that is to say, a parameter which measures the correspondence between antenna impedance and impedance of the feed line or of the device to which it is connected, in prior art omnidirectional antennas is not optimum along the whole operating band or bands, with consequent loss of efficiency in signal transmission and reception, and possible deterioration of overall system performance.

Therefore, the main problem is the difficulty simultaneously obtaining a wide band, compact dimensions and, across the whole operating band, good impedance matching, stable gain at the horizon and real omnidirectionality.

### SUMMARY OF THE INVENTION

Therefore, the aim of this invention is to overcome the above-mentioned disadvantages.

The invention, characterized as set out in the claims, achieves the aim thanks to a structural modification of the radiating body.

The main advantage obtained by means of this invention is the fact that it is possible to transmit and/or receive signals with a high gain at the horizon in all directions in a wide frequency range, guaranteeing omnidirectionality.

In addition to that, the invention has compact dimensions, therefore limiting the overall dimensions and being capable of operating without a ground plane.

Moreover, the invention allows effective operation in a very extensive frequency range.

Furthermore, the invention is capable of keeping a constant impedance in a very wide frequency range, guaranteeing optimum impedance matching with the feed line for all of the operating frequencies.

### BRIEF DESCRIPTION OF THE DRAWINGS

Further advantages and features of this invention will be more apparent in the detailed description which follows, with reference to the accompanying drawings, which show an example, non-limiting embodiment, in which:

FIG. 1 is a perspective overall view of the invention;

FIG. 2 is a perspective view of the invention of FIG. 1, with some elements removed to better illustrate others;

FIG. 3 is a perspective view of a second embodiment of the invention;

FIG. 4 is a top plan view of a first detail from FIG. 3;

FIG. 5 is a side view of a second detail of the invention;

FIG. 6 is a side view of a further embodiment of the second detail from FIG. 5;

FIG. 7 is a side overall view of the second detail from FIG. 6;

FIG. 8 is a bottom view of the first detail from FIG. 4;

FIG. 9 is an overall view of the first detail from FIG. 8;

FIG. 10 is a top plan view of a further embodiment of the first detail from FIG. 4;

FIG. 11 is an overall view of the first detail from FIG. 10;

FIG. 12 is a perspective view of the invention in a preferred construction solution;

FIG. 13 shows the solution from FIG. 12, with some parts removed to better illustrate others.

### DESCRIPTION OF THE PREFERRED EMBODIMENTS

As shown in the figures, the invention relates to a wideband omnidirectional antenna 1 comprising at least one radiating body 10, configured to transmit and/or receive electromagnetic signals.

That radiating body 10 is provided with at least an active element 15, configured to be connected to at least a feed line. That active element 15 is the only component of the radiating body 10 directly connectable to an external circuit, and is therefore configured to receive or transmit an electrical signal, operating in conjunction with the circuit to which the antenna 1 is connected.

As shown in FIG. 8, the radiating body 10 comprises at least a central parasitic element 12, positioned centrally relative to the radiating body 10, provided with at least one pair of separate conductive components 12a, 12b, spaced apart from each other.

The radiating body 10 also comprises at least a pair of lateral parasitic elements 14, positioned on the opposite sides of the central parasitic element 12. The parasitic elements 12, 14 of the antenna 1, although not being directly connectable to the feed line, participate in the radiation and/or reception of the signal by means of electromagnetic coupling with the active element 15.

Both the active element 15 and the parasitic elements 12, 14 are made of electrically conductive material.

The active element 15 is at least partly superposed both on the central parasitic element 12 and on the pair of lateral parasitic elements 14. The parasitic elements 12, 14 are electrically isolated from each other.

The coupling between the active element 15 and the parasitic elements 12, 14 is capacitive, that is to say, it occurs by means of the interaction of the electric field generated between conductive surfaces which are physically separate but near each other. Even in the absence of direct electrical contact, that configuration allows the exchange of electromagnetic energy, contributing to correct functioning of the antenna 1.

The radiating body 10 structured in this way allows a transmission and/or reception of signals with a stable and high gain in all directions in a wide frequency range, at the same time keeping dimensions compact, therefore limiting overall dimensions, and being capable of operating without the need for any auxiliary ground plane.

FIG. 8 shows a bottom plan view of the radiating body 10 of the antenna 1. Preferably, as shown in FIG. 8, the lateral parasitic elements 14 are made in a single body and are positioned symmetrically relative to the central parasitic element 12. In other words, the lateral parasitic elements 14 are positioned symmetrically relative to a longitudinal central axis A of the radiating body 10. That arrangement favors a balanced distribution of the induced currents in the lateral parasitic elements 14, improving the omnidirectionality of the antenna 1, guaranteeing a constant gain in all directions.

Moreover, each lateral parasitic element 14 may comprise a substantially rectangular first portion 21 joined to a substantially triangular second portion 22, the latter being provided with a base side coinciding with a side of the rectangular portion 21 and also being provided with a tip 23 directed towards the central parasitic element 12. That geometric shape allows a gradual and efficient electromagnetic coupling with the central parasitic element 12, optimizing the distribution of the electromagnetic field between the parts.

Alternatively, the second portion 22 may have a substantially semi-circular shape or may adopt any structure, whether regular or irregular, which has an outward narrowing, in order to obtain the same technical effect just mentioned.

To further improve the electromagnetic coupling, the tip 23 may even be truncated, in such a way as to more precisely regulate the capacitive coupling generated.

FIG. 4 shows a top plan view of the radiating body 10 of the antenna 1.

Preferably, the active element 15 comprises at least a pair of separate linear branches 24, configured for capacitive coupling with the central parasitic element 12. In this case, the active element 15 may also comprise at least a pair of end broadened members 25, each positioned on one end 24a, 24b of a respective branch 24. Those end broadened members 25 are configured for capacitive coupling with the lateral parasitic elements 14. Also preferably, each end broadened member 25 has dimensions greater, in at least one direction, than the cross-section of the linear branch 24. That allows improved capacitive coupling with the corresponding lateral parasitic elements 14.

Each branch 24 may be connected at a different electric potential, contributing to a symmetrical distribution of the currents.

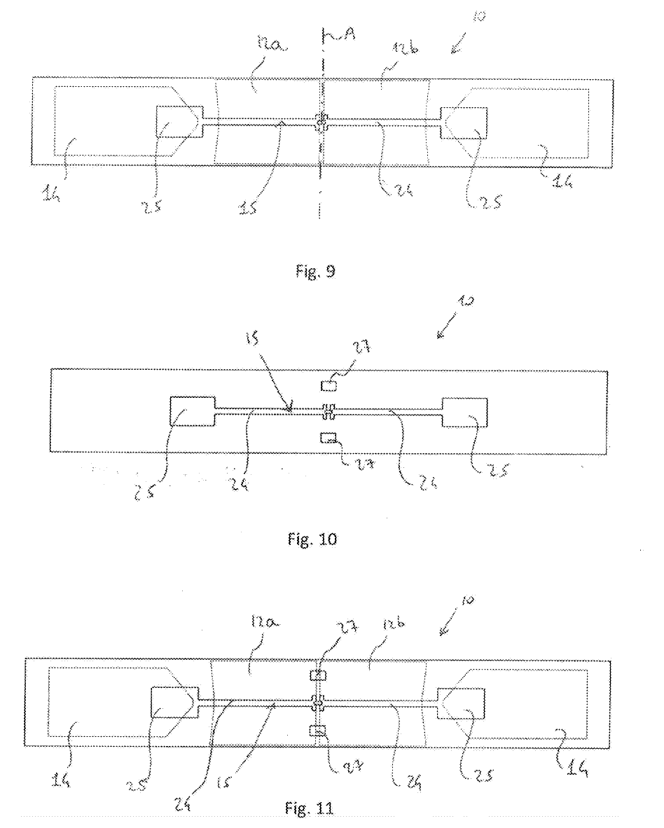

Preferably, the conductive components 12a, 12b of the central parasitic element 12 are positioned symmetrically relative to the longitudinal central axis A of the radiating body 10, shown in FIG. 9, which shows an overall view of the radiating body 10, where the at least partial superposing of the active element 15 on the parasitic elements 12, 14 is visible. The symmetrical arrangement of the conductive components 12a, 12b allows a balanced distribution of the induced currents, contributing to the stability of the gain across the whole operating band.

In a preferred embodiment, shown in FIGS. 8 and 9, the conductive components 12a, 12b have a substantially rectangular profile, wherein at least one side 13a, 13b of them, preferably the one directed towards the respective lateral parasitic element 14 has a concave curvilinear profile. In other words, the sides 13a, 13b have an inward curvature, which gives each component 12a, 12b a partly tapered appearance, characterized by a partial narrowing in the central zone. That geometric configuration is capable of changing the distribution of the induced currents on the central parasitic element 12 and the electromagnetic interaction with the surrounding environment, increasing the bandwidth of the antenna 1.

Moreover, in combination with the shape of the lateral parasitic elements 14 oriented with the tip 23 towards the center, the partly tapered shape of the components 12a, 12b of the central parasitic element 12 allows a gradual and more efficient electromagnetic coupling, thanks to the opposite structures complementing each other.

Alternatively, at least a side of at least a component 12a, 12b of the central parasitic element 12 may have a substantially semi-circular shape or may adopt any structure, whether regular or irregular, which has an inward narrowing, in order to obtain the same technical effect just mentioned.

In order to improve impedance matching with the feed line, the active element 15 may comprise at least a conductive pad 27, partly superposed on both of the conductive components 12a, 12b of the parasitic element 12 and configured for capacitive coupling with both of the conductive components 12a, 12b. By way of example and without limiting the scope of the invention, the examples shown in FIGS. 10 and 11 show an active element 15 provided with a pair of conductive pads 27. That arrangement allows improved balancing of the capacitive coupling between the active element 15 and the components 12a, 12b of the central parasitic element 12, helping to stabilize input impedance, but also increasing the operating band of the antenna 1.

The radiating body 10 may be made on a dielectric substrate, optionally a printed circuit board (PCB), in such a way as to obtain a compact planar structure which can be made repetitively and inexpensively.

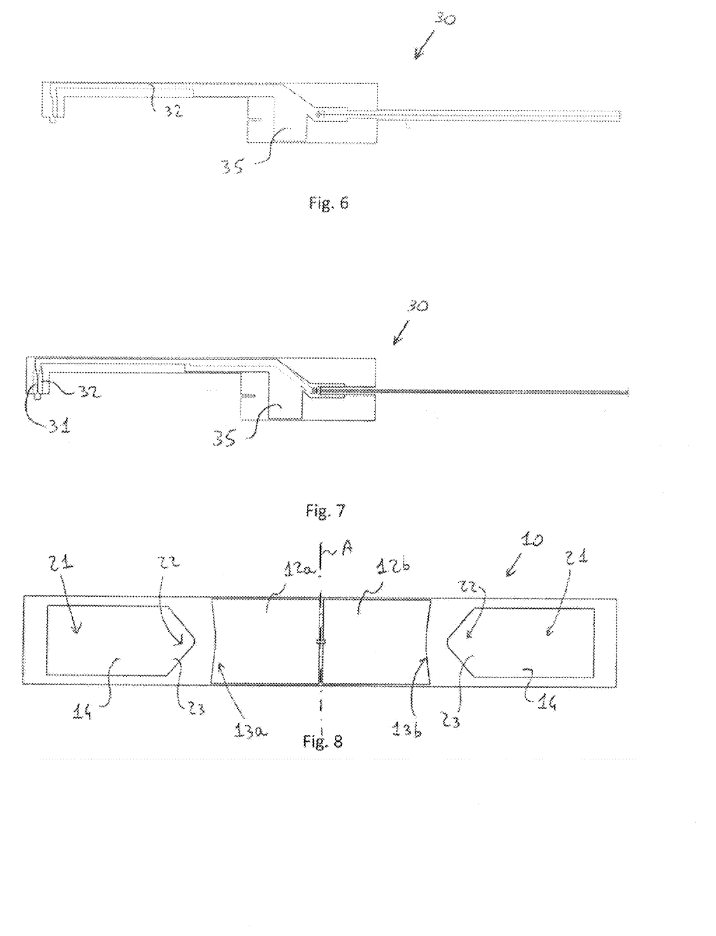

The antenna 1 according to the invention may comprise at least a feed line 30, connected to the active element 15 of the radiating body 10. The feed line 30 comprises a signal line 31, shown in FIG. 5, and a ground line 32, shown in FIG. 6. Preferably, the ground line 32 comprises at least one stretch 35 with extended conductive surface. In other words, the stretch 35 has a greater area than the typical section of the ground line 32, locally increasing the conductive surface and inducing a capacitive effect. That stretch 35, generating a capacitive effect between feed line 30 and radiating body 10, is capable of increasing the bandwidth in which the antenna 1 can operate.

FIG. 7 shows an overall view of the feed line 30, in which both the signal line 31 and the ground line 32 are visible.

The signal line 31 and the ground line 32 may be respectively connected to two separate branches 24 of the active element 15, in such a way that each branch 24 receives an electric potential opposite to the other. This differential configuration allows balanced feeding of the active element 15, reducing losses caused by unwanted radiation and improving the symmetry of the field generated.

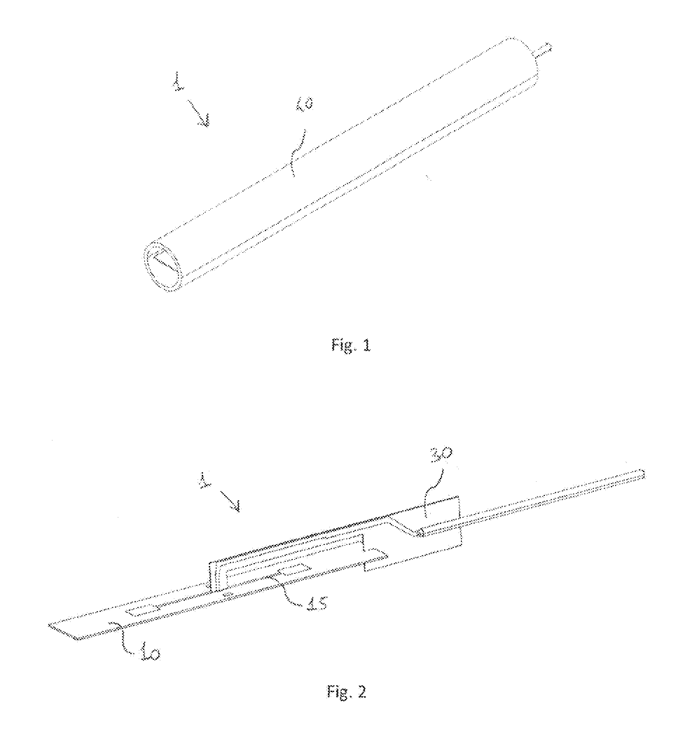

As shown in FIG. 2, the feed line 30 may be orthogonal or substantially orthogonal to the radiating body 10. That arrangement may facilitate integration of the antenna 1 in compact planar configurations. In fact, as can be seen in FIG. 1, the antenna 1 can easily be contained in a covering tube 40, preferably made of dielectric material.

The feed line 30 may also be made on a dielectric substrate, optionally a printed circuit board (PCB), in such a way as to obtain a compact planar structure which can easily be integrated in electronic devices.

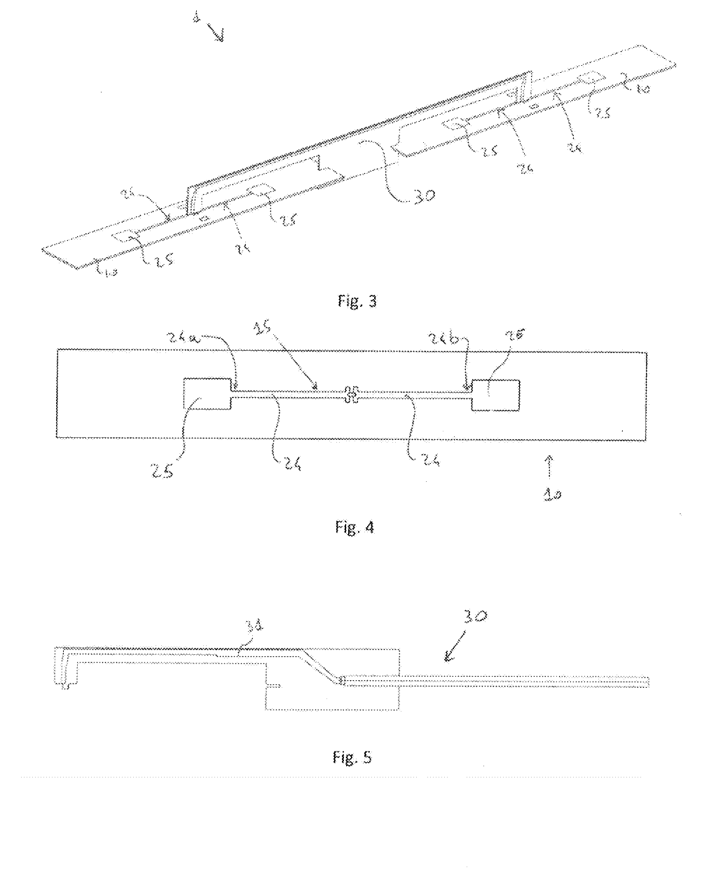

FIG. 3 shows a variant of the invention, which comprises a pair of radiating bodies 10 as previously described, positioned one after the other along a shared axis and connected to a single feed line 30 orthogonal to both of the radiating bodies 10.

This duplicated configuration allows improved performance in terms of gain, while maintaining the omnidirectionality and the impedance matching. Moreover, extending the antenna on two sections allows greater flexibility in the sizing of the individual radiating portions, facilitating adaptation to specific geometric installation constraints.

The antenna 1 according to this invention is well suited to use as a dual band antenna, that is to say, operating on a lower band and on a higher band. That can be achieved by correctly sizing the radiating body 10.

In particular, a main dimension - longitudinal, that is to say, perpendicular to the axis A - of the radiating body 10 may be formed with a length equal to half of the wavelength corresponding to the central frequency of the lower band, if necessary multiplied by a so-called shortening factor, calculated based on the materials used to make the antenna 1. Moreover, the main dimension - longitudinal - of a component 12a, 12b of the central parasitic element 12 added to the main dimension of the respective lateral parasitic element 14 and to the space present between them may be formed with a length equal to half of the wavelength corresponding to the lower frequency of the higher band, if necessary multiplied by a respective shortening factor.

Finally, the main dimension - longitudinal - of a component 12a, 12b and/or of a lateral parasitic element 14 may be formed with a length equal to half of the wavelength corresponding to the higher frequency of the higher band, if necessary multiplied by a respective shortening factor.

By way of example and without limiting the scope of the invention, the antenna 1 may be made in a dual band version for 5G system frequencies: 650-960 MHz (lower band) and 1710-4200 MHz (higher band). In this case, the antenna 1 is capable of having a standing wave ratio (VSWR) less than 2.5 for both bands. Moreover, that antenna 1 has a gain at the horizon of between 2 and 7 dBi and a radiation diagram constant at less than ± 2 dB in the horizontal plane in the worst case.

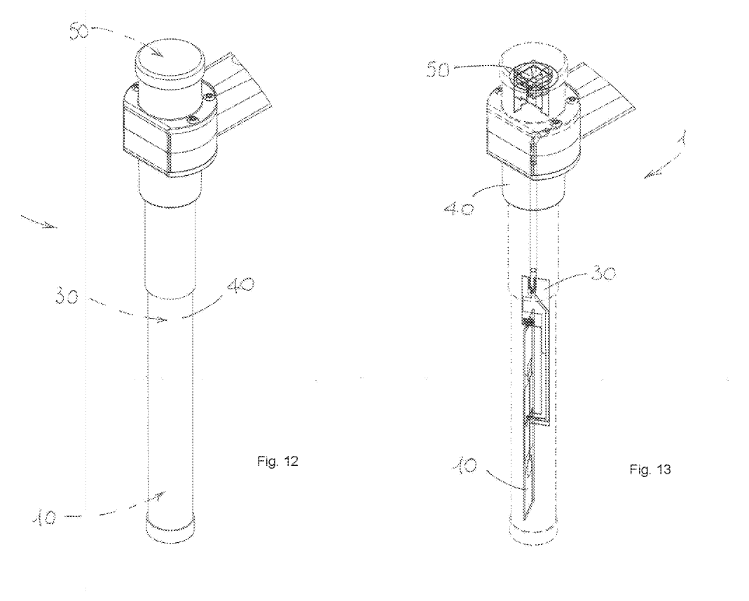

In a preferred construction solution, also housed in the covering tube 40 there is a geolocation component (50), as shown in FIGS. 12 and 13, which, for example, could be a GPS antenna.

In this case, the most favorable arrangement is positioning the geolocation component 50 directed upwards, in such a way that there are no adjacent metal parts and antennas which could compromise its proper functioning, and the radiating body 10 directed downwards.

1. A wideband omnidirectional antenna, comprising at least one radiating body provided with at least an active element, made of electrically conductive material and configured to be connected to at least a feed line, the antenna being characterized in that the radiating body comprises at least a central parasitic element positioned centrally relative to the radiating body and provided with at least one pair of separate conductive components spaced apart from each other, and at least a pair of lateral parasitic elements, positioned on the opposite sides of the central parasitic element, wherein the active element is at least partly superposed both on the central parasitic element, and on the pair of lateral parasitic elements, the parasitic elements being made of electrically conductive material and being electrically isolated from each other.

2. The antenna according to claim 1, wherein the lateral parasitic elements are made in a single body and are positioned symmetrically relative to the central parasitic element.

3. The antenna according to claim 1, wherein each lateral parasitic element comprises a substantially rectangular first portion joined to a substantially triangular second portion, the latter being provided with a base side coinciding with a side of the rectangular portion and also being provided with a tip directed towards the central parasitic element.

4. The antenna according to claim 1, wherein the active element comprises at least a pair of separate linear branches, configured for capacitive coupling with the central parasitic element and at least a pair of end broadened members, each positioned on one end of a respective branch, which are configured for capacitive coupling with the lateral parasitic elements.

5. The antenna according to claim 1, wherein the central parasitic element has a substantially rectangular profile, wherein two opposite sides directed towards the lateral parasitic elements have a concave curvilinear profile.

6. The antenna according to claim 1, wherein that the conductive components of the central parasitic element are positioned symmetrically relative to a longitudinal central axis of the radiating body.

7. The antenna according to claim 1, wherein the conductive components have a substantially rectangular profile, wherein one side of them directed towards the respective lateral parasitic element has a concave curvilinear profile.

8. The antenna according to claim 1, wherein the active element comprises at least a conductive pad, partly superposed on both of the conductive components of the parasitic element and configured for capacitive coupling with both of the conductive components.

9. The antenna according to claim 1, wherein the radiating body is made on a dielectric substrate, optionally a printed circuit board.

10. The antenna according to claim 1, wherein it comprises at least a feed line connected to the active element of the radiating body, comprising a signal line and a ground line, wherein the ground line comprises at least one stretch with extended conductive surface.

11. The antenna according to claim 10, wherein the feed line is orthogonal or substantially orthogonal to the radiating body.

12. The antenna according to claim 1, wherein the feed line is made on a dielectric substrate, optionally a printed circuit board.

13. The antenna according to claim 1, wherein it comprises a geolocation component housed in a single covering tube.

14. The antenna according to claim 13, wherein the geolocation component is directed upwards and the radiating body is directed downwards.
